(19) United States
(12) Patent Application Publication
(10) Pub. No.: US 2020/0403958 A1
(43) Pub. Date: Dec. 24, 2020

(54) SYSTEMS AND METHODS FOR PROVIDING MESSAGE THREADS ACROSS MULTIPLE PLATFORMS

(71) Applicant: Facebook, Inc., Menlo Park, CA (US)

(72) Inventors: Kemal El Moujahid, Belmont, CA (US); Li Yang, Palo Alto, CA (US); Henri Romeo Liriani, San Francisco, CA (US); Tao Jiang, Newark, CA (US); Xu He, Fremont, CA (US)

(21) Appl. No.: 16/177,263

(22) Filed: Oct. 31, 2018

(51) Int. Cl. H04L 12/58

(52) U.S. Cl. CPC H04L 51/36; H04L 67/02

(57) ABSTRACT

Systems, methods, and non-transitory computer readable media can determine information associated with a web page being accessed by a user operating a computing device. The information associated with the web page can be verified. A messaging interface for exchanging messages with an entity associated with the web page can be provided. The messaging interface can be provided within the web page being accessed.

### FIELD OF THE INVENTION

The present technology relates to the field of electronic communications. More particularly, the present technology relates to techniques for providing messaging capability across multiple platforms.

### BACKGROUND

Today, people often utilize computing devices (or systems) for a wide variety of purposes. Users can use their computing devices to, for example, interact with one another, access content, share content, and create content. In some cases, users can utilize their computing devices to communicate, such as by sending and receiving messages. For instance, users of a social networking system (or service) can, via their computing devices, exchange messages with one another through the social networking system.

### SUMMARY

Various embodiments of the present disclosure can include systems, methods, and non-transitory computer readable media configured to determine information associated with a web page being accessed by a user operating a computing device. The information associated with the web page can be verified. A messaging interface for exchanging messages with an entity associated with the web page can be provided. The messaging interface can be provided within the web page being accessed.

In an embodiment, the information includes a page identifier associated with the web page, a domain associated with the web page, and a user identifier associated with the user.

In an embodiment, a message thread for managing messages exchanged between the user and the entity is determined based on the page identifier and the user identifier.

In an embodiment, verifying the information associated with the web page further comprises: determining that the domain associated with the web page appears in a whitelist of domains that are authorized to access the messaging interface.

In an embodiment, the messaging interface is provided as an inline frame within a web browser interface through which the web page is being accessed.

In an embodiment, the inline frame is implemented as an IFrame HyperText Markup Language (HTML) element.

In an embodiment, the web page implements a message plugin, and wherein the message plugin provides the information associated with the web page.

In an embodiment, the message plugin is implemented as interpreted code embedded within the web page.

In an embodiment, the systems, methods, and non-transitory computer readable media are configured to customize the messaging interface based on one or more customization options associated with the web page, wherein the customization options include at least customizing a color scheme applied to the messaging interface.

In an embodiment, the web page is hosted by a third-party computing system.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system, according to an embodiment of the present disclosure.

FIG. 2 illustrates an example message server module, according to an embodiment of the present disclosure.

FIG. 3 illustrates an example messaging interface within a web page, according to an embodiment of the present disclosure.

FIG. 4 illustrates an example sequence diagram, according to an embodiment of the present disclosure.

FIG. 5 illustrates an example method, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Providing Message Threads Across Multiple Platforms

As mentioned, people often utilize computing devices (or systems) for a wide variety of purposes. Users can use their computing devices to, for example, interact with one another, access content, share content, and create content. In some cases, users can utilize their computing devices to communicate, such as by sending and receiving messages. For instance, users of a social networking system (or service) can, via their computing devices, exchange messages with one another through the social networking system.

Under conventional approaches, web pages can provide limited messaging capability to users. For instance, a web page can provide an interface through which users can message an entity associated with the web page. Such messages are often only visible to the user and the entity for a short duration. For example, such messages are generally not accessible once the user leaves the web page. Further, such message are generally not accessible outside of the interface provided in the web page. For example, an organization associated with the web page may also have a page published through a social networking system. In this example, messages sent by users through the page published through the social networking system will be accessible separately from messages sent by users through the interface provided in the web page. As a result, the user experience between platforms can be inconsistent, thereby hindering effective communications between users and organizations and otherwise discouraging users from engaging with organizations using messaging.

An improved approach rooted in computer technology overcomes the foregoing and other disadvantages associated with conventional approaches specifically arising in the realm of computer technology. In various embodiments, a messaging system can provide messaging capability across multiple platforms (e.g., social networking system, web sites, web pages, etc.). For example, in some embodiments, a user operating a computing device may visit a web page hosted by a computing system. The computing system may implement a message plugin within the web page. In some embodiments, the message plugin can be implemented as interpreted code embedded within the web page (e.g., JavaScript code). The message plugin can interact with a message server to provide a messaging interface that allows the user to communicate with an entity (e.g., a page owner, customer service agent, etc.) associated with the web page. For example, the messaging interface can be provided within the web page as an inline frame (e.g., an IFrame HTML element). In some embodiments, the inline frame serves as an HTML (HyperText Markup Language) document embedded within another HTML document (i.e., the web page). As a result, the inline frame can be used to insert the messaging interface within the web page. In various embodiments, the message plugin can provide the message server with information needed to identify a message thread to present within the messaging interface. For example, in some embodiments, the message plugin can determine and provide a page identifier (page ID) associated with the web page and a user identifier (user ID) associated with the user accessing the web page. The message server can use the page identifier and the user identifier to determine a message thread to provide in the messaging interface. If an existing message thread does not exist, the message server can create a new message thread for managing ongoing communication between the user and the entity associated with the web page. The message thread can continually be updated as the user and the entity send messages. The message thread can therefore maintain a history of messages exchanged between the user and the entity. In various embodiments, the message thread between the user and the entity is persistent and can be accessed using messaging interfaces provided by many different software applications (e.g., a web browser, social networking application, messaging application, etc.). It is contemplated that there can be many variations and/or other possibilities associated with the disclosed technology.

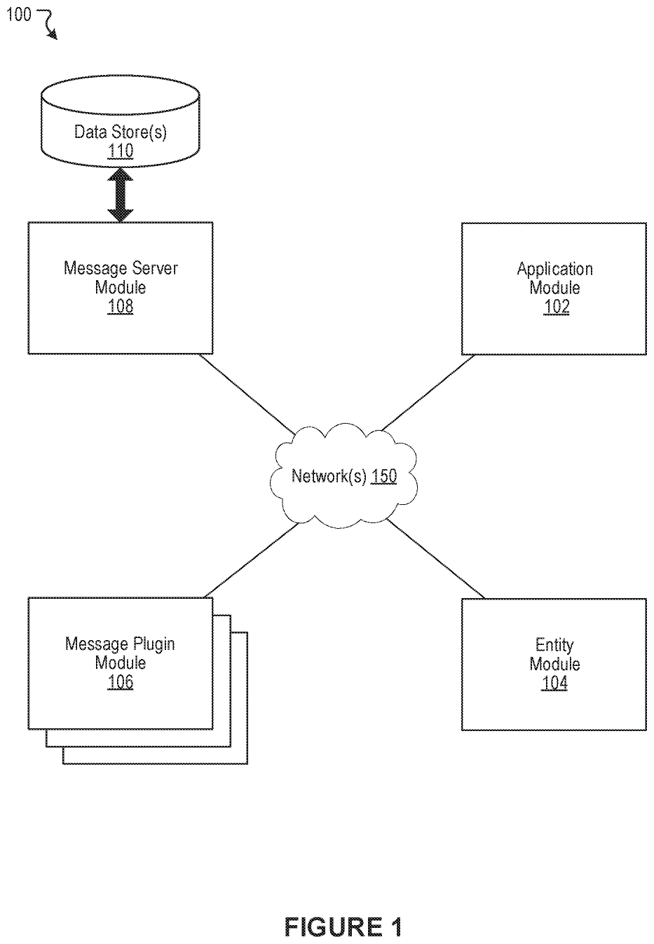

FIG. 1 illustrates an example system 100, according to various embodiments of the present disclosure. As shown in FIG. 1, the system 100 can include an application module 102, an entity module 104, a message plugin module 106, and a message server module 108. In some embodiments, the example system 100 can include at least one data store 110. The application module 102, entity module 104, the message plugin module 106, and the message server module 108 can interact with one another over one or more network(s) 150. In some embodiments, the network(s) 150 can be any wired or wireless computer network through which devices can exchange data. For example, the network(s) 150 can be a personal area network, a local area network, or a wide area network. The components (e.g., modules, elements, etc.) shown in this figure and all figures herein are exemplary only, and other implementations may include additional, fewer, integrated, or different components. Some components may not be shown so as not to obscure relevant details.

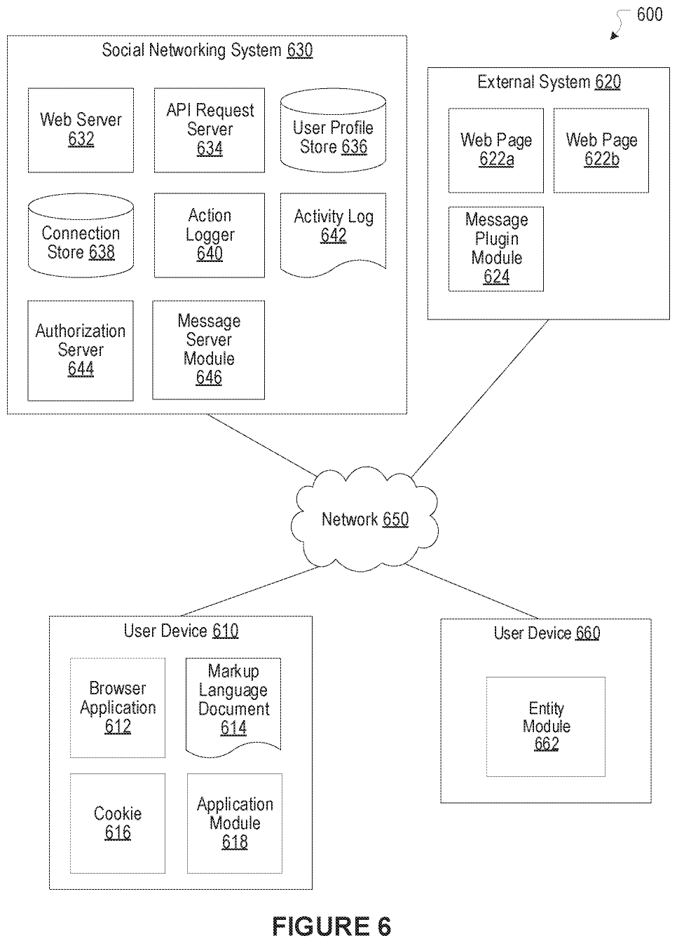

In various embodiments, the application module 102, entity module 104, the message plugin module 106, and the message server module 108 can be implemented, in part or in whole, as software, hardware, or any combination thereof. In general, a module as discussed herein can be associated with software, hardware, or any combination thereof. In various embodiments, one or more functions, tasks, and/or operations of modules can be carried out or performed by software routines, software processes, hardware, and/or any combination thereof. In various embodiments, one or more of the application module 102, entity module 104, the message plugin module 106, and the message server module 108, or at least portions thereof, can be implemented using one or more computing devices or systems that include one or more servers, such as network servers or cloud servers. In various embodiments, the message server module 108 can, in part or in whole, be implemented within or configured to operate in conjunction with a social networking system (or service), such as the social networking system 630 of FIG. 6. In various embodiments, the application module 102 can be, in part or in whole, implemented within or configured to operate in conjunction or be integrated with a client computing device, such as the user device 610 of FIG. 6. In various embodiments, the entity module 104 can be, in part or in whole, implemented within or configured to operate in conjunction or be integrated with a client computing device, such as the user device 660 of FIG. 6. In various embodiments, the message plugin module 106 can be, in part or in whole, implemented within or configured to operate in conjunction or be integrated with a computing system, such as the external system 620 of FIG. 6. For example, the external system 620 can implement the message plugin module 106 in a web page, such as the web page 622a, 622b of FIG. 6. It should be understood that many variations are possible. In various embodiments, the application module 102, entity module 104, the message plugin module 106, and the message server module 108 can be implemented as or within a dedicated application (e.g., app), a program, or an applet running on a user computing device or client computing system. In various embodiments, the application incorporating or implementing instructions for performing some, or all, functionality of the application module 102, entity module 104, the message plugin module 106, and the message server module 108 can be created by a developer. In various embodiments, the application can be provided to or maintained in a repository. In various embodiments, the application can be uploaded or otherwise transmitted over a network (e.g. Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

In various embodiments, the message server module 108 can be configured to communicate and/or operate with the at least one data store 110 in the example system 100. The at least one data store 110 can be configured to store and maintain various types of data. In some embodiments, the at least one data store 110 can store data relevant to function and operation of the message server module 108. Some examples of such data can include message threads for managing messages exchanged between various users, messages that have been exchanged between users in a given message thread, corresponding page identifiers (IDs) for identifying web pages within which the message plugin module 106 has been implemented, associations between message threads and corresponding user IDs and page IDs, etc. In some embodiments, the at least one data store 110 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some embodiments, the at least one data store 110 can store information associated with users, such as user identifiers, user information, profile information, user specified settings, content produced or posted by users, and various other types of user data. It should be appreciated that there can be many variations or other possibilities.

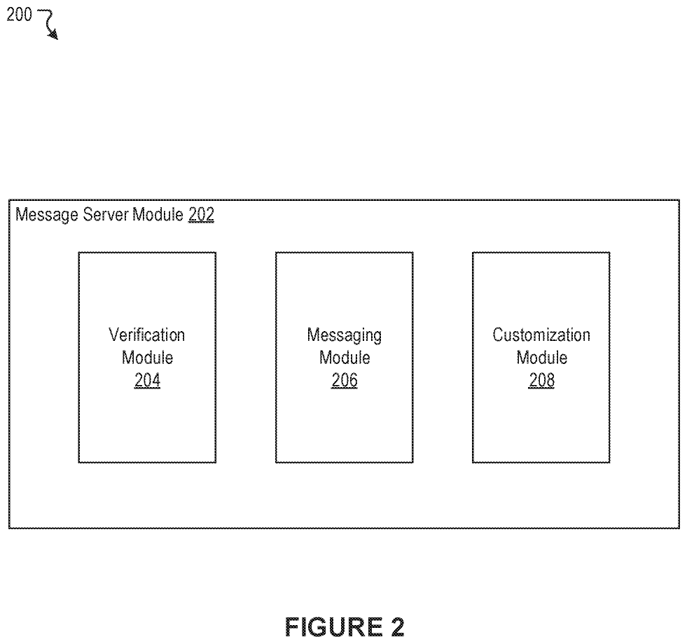

The application module 102 can provide users with an interface for accessing content. For example, the interface may be provided by a software application (e.g., web browser, social networking application, messaging application, etc.) running on a computing device. For example, a user operating the computing device can interact with the interface to access various content (e.g., web sites, web pages, etc.). For example, the user can specify a uniform resource locator (URL) that references a given web page. In this example, the software application can retrieve and provide the web page within the provided interface. In some instances, a computing system (e.g., a third-party computing system) hosting the web page may implement the message plugin module 106. In such instances, the message plugin module 106 can be configured to provide messaging capability between the user and an entity (e.g., page owner, customer service agent, etc.) associated with the web page. In some embodiments, the message plugin module 106 can be implemented as interpreted code embedded within the web page (e.g., JavaScript code). For example, in some embodiments, the message plugin module 106 can provide a messaging interface within the web page as an inline frame (e.g., an IFrame HTML element). In some embodiments, the inline frame serves as an HTML (HyperText Markup Language) document embedded within another HTML document (i.e., the web page). The user can interact with the messaging interface to send and receive messages with the entity associated with the web page. In various embodiments, the message plugin module 106 can interact with a messaging server that implements the message server module 108 to provide the messaging interface. The entity associated with the web page can exchange messages with the user through an interface provided by the entity module 104. For example, the interface may be provided by a software application (e.g., web browser, social networking application, messaging application, etc.) running on a computing device being operated by the entity. In various embodiments, the entity module 104 can be configured to interact with the message server module 108 to send and receive messages to users. In general, messages exchanged between the user and the entity can be delivered and managed within a persistent message thread. This persistent message thread can be accessed by the user and the entity using messaging interfaces provided by a number of different software applications (e.g., web browser, social networking application, messaging application, etc.). For example, the user can use the interface provided by the application module 102 to message the entity associated with the web page. In this example, the entity can respond to the user using an interface provided by a messaging application that implements the entity module 104. In various embodiments, the persistent message thread and its related content can be stored and managed by the message server module 108. More details regarding the message server module 108 are provided in reference to FIG. 2.

FIG. 2 illustrates an example message server module 202, according to various embodiments of the present disclosure. In some embodiments, the message server module 108 of FIG. 1 can be implemented as the message server module 202. As shown in FIG. 2, the message server module 202 can include a verification module 204, a messaging module 206, and a customization module 208. The components (e.g., modules, elements, etc.) shown in this figure and all figures herein are exemplary only, and other implementations may include additional, fewer, integrated, or different components. Some components may not be shown so as not to obscure relevant details.

The verification module 204 can be configured to verify information associated with web pages. In some embodiments, when a user accesses a given web page, a message plugin (e.g., the message plugin module 106 of FIG. 1) implemented in the web page can provide the verification module 204 with a page identifier and a domain (e.g., domain name, IP address, etc.) associated with the web page. In this example, the verification module 204 can determine whether the domain and the page identifier are included in a whitelist of domains that are authorized to interact with the message server module 202 for purposes of providing a messaging interface for communicating with an entity associated with the web page. In this example, if the domain is authorized, then a messaging interface for messaging an entity associated with the web page can be provided in the web page. In contrast, if the domain is not authorized, then the messaging interface is not provided within the web page. The verification module 204 can also verify a user identifier associated with the user accessing the web page. In some embodiments, the user identifier can be used in conjunction with the page identifier to determine (or identify) a message thread to present to the user within the messaging interface provided in the web page. In an embodiment, the verification module 206 can verify the user identifier by redirecting the user to a login page through which the user enters login information. In another embodiment, the verification module 206 can verify the user identifier by displaying an interstitial login page through which the user enters login information. In another embodiment, the verification module 206 can verify the user identifier based on a token associated with a user (e.g., a login token stored in a web browser cookie).

The messaging module 206 can provide messaging functionality for messaging interfaces provided within web pages. For example, the messaging module 206 can allow a user to send and receive messages through a messaging interface provided in a web page. For example, the messaging interface can be provided within the web page as an inline frame. In some embodiments, the messaging module 206 can determine a message thread to present within the messaging interface based on a user identifier associated with the user and a page identifier associated with the web page. Once a message thread associated with the user identifier and the page identifier is identified, the messaging module 206 can present the message thread within the messaging interface provided in the web page.

The customization module 208 can apply various customizations to a messaging interface provided within a web page. For example, the web page may be associated with one or more customizations that can be applied to a messaging interface provided in the web page. In some embodiments, the customization module 208 can apply a color scheme to a messaging interface provided in the web page. For example, the messaging interface can be presented in different colors, fonts, sizes, and/or designs. In some embodiments, a color scheme can be applied to message bubbles shown in the messaging interface. In some embodiments, the messaging interface can include a customized set of options for interacting with an entity associated with the web page. In some embodiments, the messaging interface can display customized content (e.g., a logo, an interstitial message, etc.). Such customized content can also include content determined based on user interaction with the web page. For example, the user may interact with the web page to make a purchase. In this example, a receipt documenting the purchase can be provided as a message in the messaging interface. Many variations are possible.

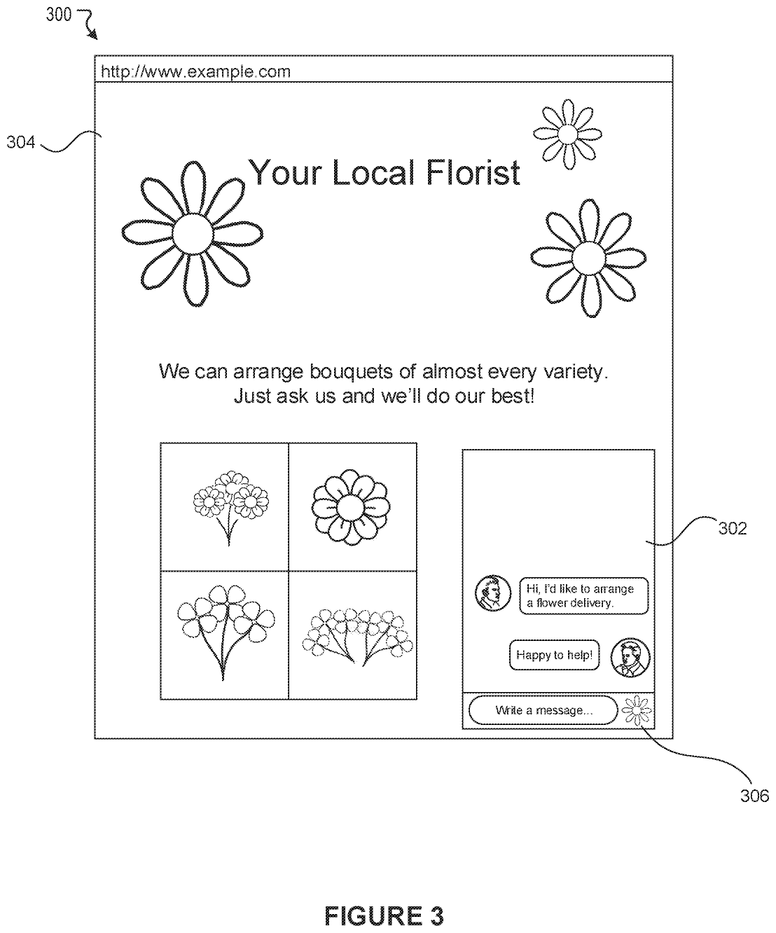

FIG. 3 illustrates an example 300 of a messaging interface 302, according to an embodiment of the present disclosure. In this example, the messaging interface 302 is presented within a web page 304 being accessed by a user. For example, the web page 304 may be shown through a display screen of a computing device being operated by the user. In this example, the web page 304 is being accessed through a web browser application running on the computing device 402. As shown in the example of FIG. 3, the user can interact with an entity associated with the web page 304 using the messaging interface 302. A message plugin can interact with a message server to provide the messaging interface 302, as described above. The messaging interface 302 includes a design 306 that constitutes a customization of the messaging interface 302 that is associated with the entity.

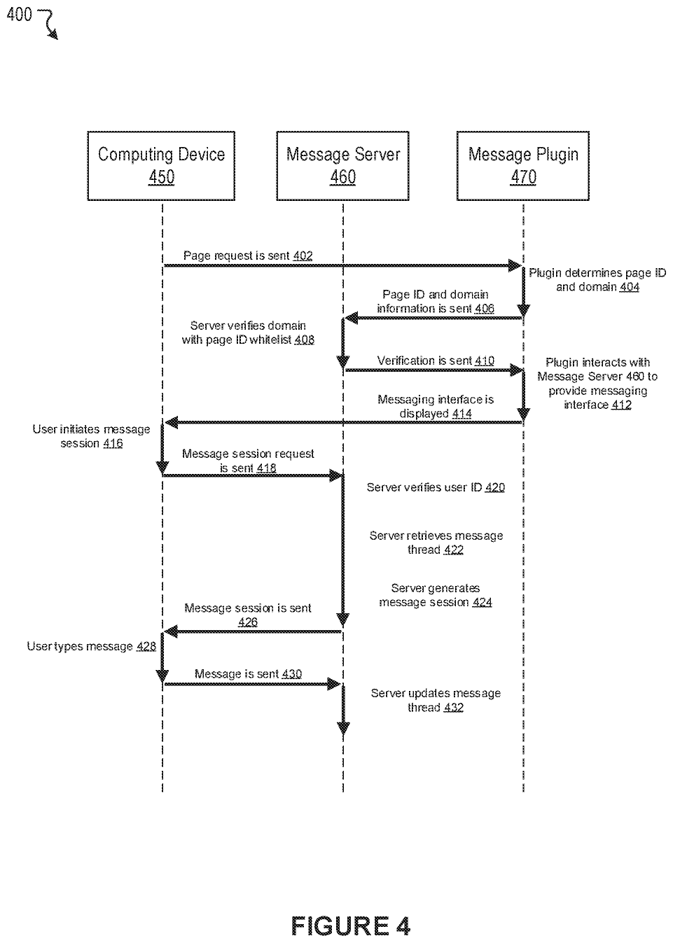

FIG. 4 illustrates an example sequence diagram 400, according to various embodiments of the present disclosure. The example sequence diagram 400 illustrates example interactions between a computing device 450 of a user, a message server 460, and a message plugin 470. It should be appreciated that there can be additional, fewer, or alternative steps performed in similar or alternative orders, or in parallel, within the scope of the various embodiments unless otherwise stated.

At step 402, the computing device 450 being operated by the user can send a page request. The page request indicates that the user has requested a web page in which the message plugin 470 has been implemented. At step 404, the message plugin 470 determines the page identifier (page ID) associated with the message plugin and the domain associated with the page request. At step 406, the message plugin 470 sends the page ID and domain information to the message server 460. At step 408, the message server 460 verifies the domain with a whitelist associated with the page ID. At step 410, the message server 460 sends verification that the domain is a whitelisted domain. At step 412, the message plugin interacts with the message server 460 to provide a messaging interface for the computing device 450 of the user. For example, the message plugin can interact with the message server 460 through an application programming interface (API) provided by the message server 460. The messaging interface can be used, for example, to send and receive messages through the message server 460. At step 414, the messaging interface is displayed within the web page that the computing device 450 of the user requested. At step 416, the computing device 450 of the user uses the messaging interface to initiate a message session with the web page owner. At step 418, the message session request is sent to the message server 460. At step 420, the message server 460 verifies the user ID associated with the user of the computing device 450. The user ID may be verified based on, for example, an interstitial login page or existing credentials. At step 422, upon verification of the user ID, the message server 460 retrieves the message thread associated with the user ID and page ID. At step 424, the message server 460 generates a message session. At step 426, the message session is sent to the computing device 450 of the user. At step 428, the user of the computing device 450 types a message. At step 430, the message is sent to the message server 460. At step 432, the message server 460 updates the message thread with the message sent by the user of the computing device 450.

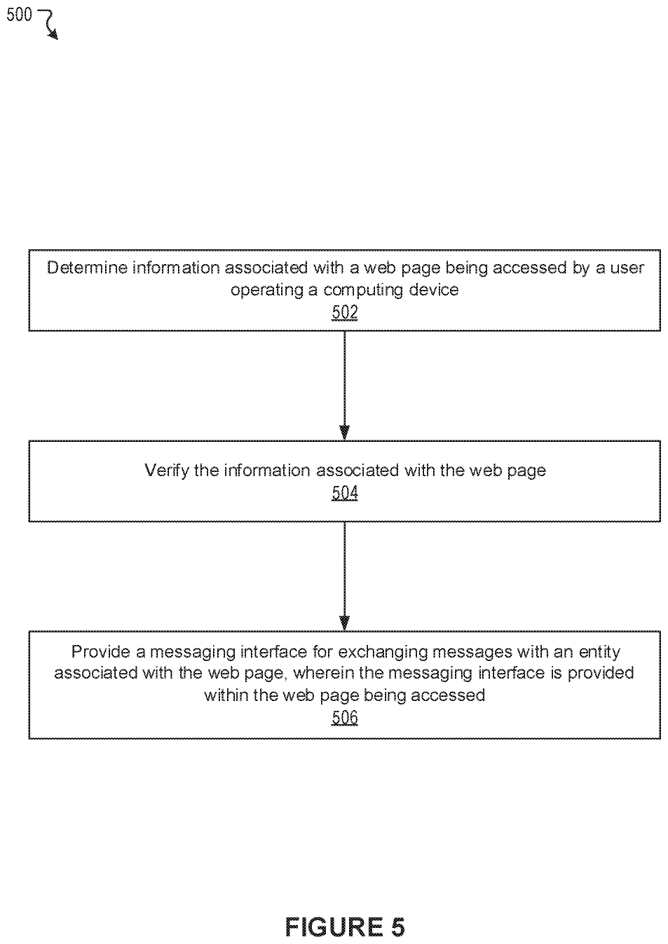

FIG. 5 illustrates an example method 500, according to various embodiments of the present disclosure. As discussed, it should be understood that there can be additional, fewer, or alternative steps performed in similar or alternative orders, or in parallel, within the scope of the various embodiments unless otherwise stated.

At block 502, information associated with a web page being accessed by a user operating a computing device is determined. At block 504, the information associated with the web page is verified. At block 506, a messaging interface for exchanging messages with an entity associated with the web page is provided. The messaging interface can be provided within the web page being accessed.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet. In some embodiments, the social networking system 630 can include or correspond to a social media system (or service).

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11 (e.g., Wi-Fi), worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620. In another embodiment, the message plugin module 106 of FIG. 1 communicates with the social networking system 630 via APIs

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a message server module 646. The message server module 646 can, for example, be implemented as the message server module 108 of FIG. 1. In some embodiments, the user device 610 can include an application module 618. The application module 618 can, for example, be implemented as the application module 102 of FIG. 1. In some embodiments, an entity module 662 can be implemented in a user device 660. The entity module 662 can, for example, be implemented as the entity module 104 of FIG. 1. In some embodiments, a message plugin module 624 can be implemented in the external system 620. The message plugin module 624 can, for example, be implemented as the message plugin module 106 of FIG. 1. As discussed previously, it should be appreciated that there can be many variations or other possibilities.

### Hardware Implementation

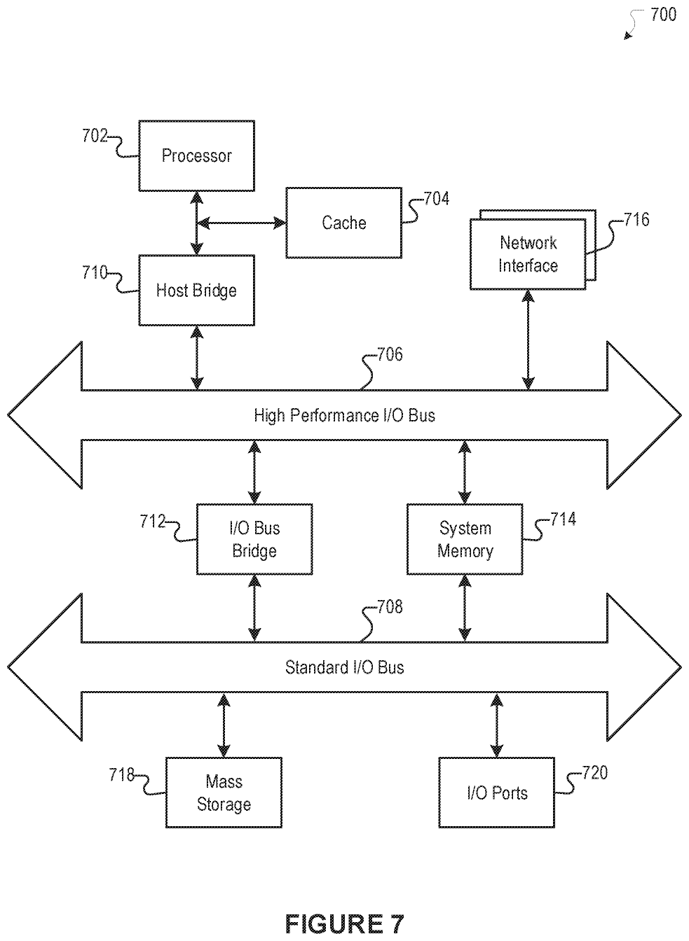

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments. Furthermore, reference in this specification to “based on” can mean “based, at least in part, on”, “based on at least a portion/part of”, “at least a portion/part of which is based on”, and/or any combination thereof.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
determining, by a computing system, information associated with a web page being accessed by a user operating a computing device;
verifying, by the computing system, the information associated with the web page;
providing, by the computing system, a messaging interface for exchanging messages with an entity associated with the web page, wherein the messaging interface is provided within the web page being accessed; and
customizing, by the computing system, the messaging interface based on at least one customization option associated with the web page, wherein the at least one customization option causes customized content associated with the web page to be displayed within the messaging interface.

2. The computer-implemented method of claim 1, wherein the information includes a page identifier associated with the web page, a domain associated with the web page, and a user identifier associated with the user.

3. The computer-implemented method of claim 2, wherein a message thread for managing messages exchanged between the user and the entity is determined based on the page identifier and the user identifier.

4. The computer-implemented method of claim 2, wherein verifying the information associated with the web page further comprises:
determining, by the computing system, that the domain associated with the web page appears in a whitelist of domains that are authorized to access the messaging interface.

5. The computer-implemented method of claim 1, wherein the messaging interface is provided as an inline frame within a web browser interface through which the web page is being accessed.

6. The computer-implemented method of claim 5, wherein the inline frame is implemented as an IFrame HyperText Markup Language (HTML) element.

7. The computer-implemented method of claim 1, wherein the web page implements a message plugin, and wherein the message plugin provides the information associated with the web page.

8. The computer-implemented method of claim 7, wherein the message plugin is implemented as interpreted code embedded within the web page.

9. (canceled)

10. The computer-implemented method of claim 1, wherein the web page is hosted by a third-party computing system.

11. A system comprising:
at least one processor; and
a memory storing instructions that, when executed by the at least one processor, cause the system to perform:
determining information associated with a web page being accessed by a user operating a computing device;
verifying the information associated with the web page;
providing a messaging interface for exchanging messages with an entity associated with the web page, wherein the messaging interface is provided within the web page being accessed; and
customizing the messaging interface based on at least one customization option associated with the web page, wherein the at least one customization option causes customized content associated with the web page to be displayed within the messaging interface.

12. The system of claim 11, wherein the information includes a page identifier associated with the web page, a domain associated with the web page, and a user identifier associated with the user.

13. The system of claim 12, wherein a message thread for managing messages exchanged between the user and the entity is determined based on the page identifier and the user identifier.

14. The system of claim 12, wherein verifying the information associated with the web page further comprises:
determining that the domain associated with the web page appears in a whitelist of domains that are authorized to access the messaging interface.

15. The system of claim 11, wherein the messaging interface is provided as an inline frame within a web browser interface through which the web page is being accessed.

16. A non-transitory computer-readable storage medium including instructions that, when executed by at least one processor of a computing system, cause the computing system to perform a method comprising:
determining information associated with a web page being accessed by a user operating a computing device;
verifying the information associated with the web page;
providing a messaging interface for exchanging messages with an entity associated with the web page, wherein the messaging interface is provided within the web page being accessed, and
customizing the messaging interface based on at least one customization option associated with the web page, wherein the at least one customization option causes customized content associated with the web page to be displayed within the messaging interface.

17. The non-transitory computer-readable storage medium of claim 16, wherein the information includes a page identifier associated with the web page, a domain associated with the web page, and a user identifier associated with the user.

18. The non-transitory computer-readable storage medium of claim 17, wherein a message thread for managing messages exchanged between the user and the entity is determined based on the page identifier and the user identifier.

19. The non-transitory computer-readable storage medium of claim 17, wherein verifying the information associated with the web page further comprises:
determining that the domain associated with the web page appears in a whitelist of domains that are authorized to access the messaging interface.

20. The non-transitory computer-readable storage medium of claim 16, wherein the messaging interface is provided as an inline frame within a web browser interface through which the web page is being accessed.
